(19) United States
(12) Patent Application Publication
(10) Pub. No.: US 2008/0126449 A1
(43) Pub. Date: May 29, 2008

(54) Method of Distributing Data Files and Memory System for Storing Data Files

(75) Inventor: Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,539

(22) PCT Filed: Jul. 4, 2005
(86) PCT No.: PCT/IB05/52217

§ 371 Date: Jan. 2, 2007

(30) Foreign Application Priority Data
Jul. 7, 2004 (EP) 04103222.8

(51) Int. Cl. G06F 12/00

(52) U.S. Cl. 707/205; 711/E12.001

(57) ABSTRACT

The invention relates to a method of distributing data files to a memory system having more than one memory devices. Each of the memory devices being arranged for storing at least one data file. The steps of the method comprise acquiring speed indicators indicating the writing speed of data into each memory device (S1); defining a distribution scenario according to the acquired speed indicators (S2); and distributing data files to the memory devices according to the defined distribution scenario (S3).

### FIELD OF THE INVENTION

The invention relates to a method of distributing data files to a memory system having more than one memory devices.

The invention further relates to a memory system for storing data files being operable by the method of the invention.

The invention further relates to a host system for transferring data files to a memory system.

### BACKGROUND OF THE INVENTION

In recent times, memory systems which comprise non-volatile semiconductor memory devices, such as flash memory cards, are more and more used instead of the conventional magnetic memory devices, such as hard discs or floppy disks. Due to the high integration factor which can be achieved nowadays, the storage capacity of such semiconductor memory devices has increased to an extend that allows the storage of a considerable amount of digital data files.

The advantage of semiconductor memory devices like flash memory cards is that they are less prone to environmental influences like magnetic fields, impacts or temperature fluctuations. Furthermore, they do not have mechanical parts like a rotating disk which are prone to wear and do have a considerable less energy consumption. Therefore, non-volatile semiconductor memory devices such as flash memory cards are more and more used as storage element for a variety of portable multimedia devices which need to permanently store digital data files requiring a substantial amount of storage capacity even if they had been compressed beforehand. For example, digital voice recorders or mp3-players use a flash memory card as interchangeable memory devices.

However, due to the high manufacturing costs and restrictions of the manufacturing technique, non-volatile semiconductor memory devices are still limited to some hundred megabytes whereas small hard discs have a capacity in order of gigabytes. In order to overcome this limitation, a memory system can be comprised of more than one non-volatile semiconductor memory devices.

For example, EP 1 083 474 discloses a terminal apparatus and a recording method which uses two slots for memory cards to be releasable inserted in the terminal apparatus. The terminal apparatus can be connected to a host system like a personal computer via USB, FireWire or RS/232C interface means for interchanging data with a host based memory system.

Another example are portable multimedia devices like an mp3 player which have a second memory expansion slot for a second flash memory card in order to increase the memory capacity for the digital audio files. The mp3 player can also be connected to a host system like a personal computer using a serial connection like USB, FireWire or RS/232C.

However, the data transfer rates, i.e. the reading and writing of data from and to a flash memory card are rather slow compared to that of hard discs and/or of the serial interfaces means. Hence, if the memory system is to receive digital data files through its serial interfaces means from, for example, a PC, the slow writing speed of the flash card to be written on will jam up the incoming files to the memory system.

EP 1 083 474 discloses the distribution of data files to the different memory devices under consideration of copyright-indicators. However, although EP 1 083 474 uses more than one semiconductor memory device, it does not disclose any increasing of data transfer to the memory system, i.e. the recording speed of the memory system remains unchanged.

### OBJECT AND SUMMARY OF THE INVENTION

Therefore, it is an object of the invention to provide a method as defined in the opening paragraph, to provide a memory system as defined in the second paragraph and to provide a host system as defined in the third paragraph, in which the disadvantages defined above are avoided.

This object is solved by each feature combination defined in claim 1, claim 8 and claim 14.

Further embodiments and advantageous modifications are subject to the depending claims and are herewith entirely incorporated in the description by reference so that repetition of their literally wording can be omitted.

In order to achieve the object defined above with a method according to the invention characteristic features are provided so that a method according to the invention may be characterized in the way defined below, that is:

Method of distributing data files to a memory system having more than one memory devices, each being arranged for storing at least one data file comprising the following steps of acquiring speed indicators indicating the writing speed of data into each memory device; defining a distribution scenario according to the acquired speed indicators; and distributing data files to the memory devices according to the defined distribution scenario.

The characteristic features according to the invention has the advantage that the method provides for a substantially increased writing speed of data files to a memory system. Hence, the method improves the effectiveness and applicability of memory systems using this method.

In order to achieve the objects defined above, with a memory system according to the invention characteristic features are provided so that a memory system according to the invention can be characterized in the way defined below, that is:

Memory system for storing data files comprising at least two memory devices; means for acquiring speed indicators indicating the writing speed of data into each memory device; means for defining a distribution scenario according to the acquired speed indicators, wherein the means for defining a distribution scenario are arranged for a cooperation with the means for acquiring speed indicators, and means for distributing data files to the memory devices according to the defined distribution scenario. The characteristic features according to the invention has the advantage that the memory system provides a substantially increased writing speed of data files to a memory system. Hence, the memory system comprises improved effectiveness and applicability in multimedia devices.

A further embodiment of the invention according to claim 2 provides the advantage of improved effectiveness for the method according to claim 1 because writing speed is balanced against the available memory space.

A further embodiment of the invention according to claim 3 provides the advantage that the method according to claim 1 or 2 is also applicable to systems which are modified during their use or in which the memory device specifications are not predefined.

A further embodiment of the invention according to claim 4 provides the advantage that the method is ready to use immediately for the memory system upon completion of an installation of new memory devices.

A further embodiment of the invention according to claim 5 provides the advantage of improved effectiveness for the method according to claim 1 to 4.

A further embodiment of the invention according to claim 6 provides the advantage that the method according to claim 1 to 5 is usable with a programmable device or system.

A further embodiment of the invention according to claim 7 provides the advantage that the method can be easily distributed to a plurality of programmable device or systems.

A further embodiment of the invention according to claim 9 provides the advantage that the memory system is easily to apply to different memory configuration.

A further embodiment of the invention according to claim 10 provides the advantage of improved effectiveness for the memory system according to claim 8 or 9.

A further embodiment of the invention according to claim 11 provides the advantage that the memory system can be used with many different serial transfer techniques and is therefore generally applicable.

A further embodiment of the invention according to claim 12 provides the advantage that the memory system according to claim 8 to 11 is usable with a multimedia device.

A further embodiment of the invention according to claim 13 provides the advantage that the multimedia device according to claim 12 is usable as a MP3-player.

In order to achieve the object defined above with a host system according to the invention characteristic features are provided so that a host system according to the invention may be characterized in the way defined below, that is:

Host system for transferring data files to a memory system, which memory system is arranged for storing data files and comprise at least two memory devices therefore, comprising means for acquiring speed indicators indicating the writing speed of each memory device; means for defining a distribution scenario according to the acquired speed indicators, wherein the means for defining a distribution scenario are arranged for a cooperation with the means for acquiring speed indicators, and means for distributing digital data files to the memory devices according to the defined distribution scenario. The characteristic features according to the invention has the advantage that the host system provides for a substantially increased writing speed of data files to a memory system. Hence, the host system comprises improved effectiveness and applicability with multimedia devices.

The aspect defined above and further aspects of the invention are apparent from the examples of embodiments to be described hereinafter and are explained with reference to these examples of embodiments.

### BRIEF DESCRIPTION OF THE DRAWINGS

The invention will be described hereinafter with reference to examples to the embodiments but to which the invention is not limited.

FIG. 1 shows a multimedia system with a memory system according to the invention in form of a block diagram.

FIG. 2 shows a memory system according to the invention in form of a block diagram.

FIG. 3 shows a host system according to the invention in form of a block diagram.

FIG. 4 shows a method according to the invention in form of a flow chart.

FIG. 5 shows a modified method according to the invention in form of a flow chart.

FIGS. 6 and 7 show methods for defining of file distribution scenarios in form of a flow chart.

### DESCRIPTION OF EMBODIMENTS

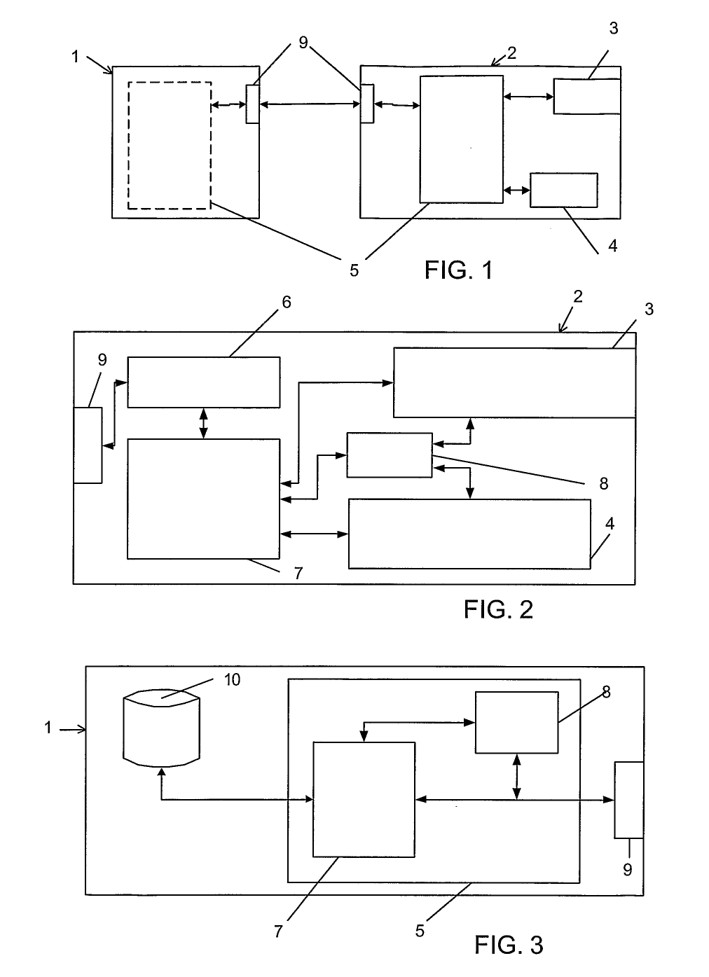

FIG. 1 shows a multimedia system in which data files are distributed to memory devices 3 and 4 through file distribution means 5 using the method for distributing data files of the invention. The system basically consists of a host 1, for example a PC, which is connected through serial interface means 9 to a multimedia device 2 having at least two memory devices 3 and 4. In this embodiment the multimedia device is an MP3-player which has two flash memory cards 3 and 4. Hence, the data files are music files of the well-known MP3 format. In this embodiment of the invention, the flash memory card 4 is fixedly installed in the MP3-player and flash memory card 3 is detachable inserted via an extension slot. However, embodiments of the invention are conceivable which use only fixed or only detachable memory devices such as flash memory cards. Preferably, the flash memory cards comprised the same size and storage capacity. However, it is conceivable to use cards of different size and with different storage capacity.

The MP3-player 2 contains file distribution means 5 which receive data files from the host system and distributes them to one of the flash memory cards 3 or 4 connected to it. In another embodiment of the invention, the file distribution means 5 are alternatively included in the host system 1. The file distribution means 5 distribute incoming data files according to a file distribution scenario which has been defined according to speed indicators of the flash memory cards. Within this invention, speed indicators are defined as data representing the writing speed of the memory devices.

FIG. 2 shows the MP3-player 2 of FIG. 1 in more detail. The MP3-player 2 comprises two flash memory cards 3 and 4 which are connected for a file data transfer with a file distribution stage 7 in which the scenarios for distributing of incoming data files are defined. The file distribution stage 7 is connected to speed indicator means 8 which in turn are connected to each one of the flash memory cards 3 and 4. The speed indicator means 8 are provided for acquiring speed indicator data of each flash memory card 3 and 4.

Furthermore, the MP3-player includes intermediate storage means 6 like a buffer which can also be integrated within the file distribution stage 7 when necessary. However, in this embodiment the intermediate storage means 6 are provided separately and are connected to the file distribution stage 7 via data connection. The intermediate storage means 6 are connected to the serial interface means 9 for receiving data from, for example, the host 1. All data connections lines shown in the drawing are bi-directional data connections which can be either serial or parallel according to the respective specification.

FIG. 3 shows an embodiment of the invention where the file distributing means 5 are provided in the host 1. The file distribution means 5 are connected to the serial interface means 9 and to the file memory 10, which in this embodiment is a magnetic hard disc. As in the embodiment shown in FIG. 2, the file distribution means 5 include a file distribution stage 7 for defining and storing an appropriate file distribution scenario and speed indicator means 8 which are connected to each other.

As explained with reference to FIG. 2, the speed indicator means 8 are provided for acquiring speed indicator data of each flash memory card 3, 4. There are two ways of acquiring the speed indicator data:

1) The speed indicator means 8 write a test file of a predetermined size (e.g. one megabyte of size) to the flash memory card 3 (card 1). After completion of writing of the test file to card 1, a ready signal is sent by card 1 to the speed indicator means 8 and the speed indicator means 8 determine the time required for writing the test file. The measured value is the speed indicator for card 1 which is transmitted to the file distribution stage 7. The speed indicator means 8 repeat the same procedure with the flash memory card 4 (card 2) to obtain a second speed indicator value for card 2.

2) The second way for acquiring speed indicators for each of the memory devices available in the MP3-player is to use internal data which have been pre-configured within the cards. For example, the writing speed value of a flash card is internally stored in a ROM, e.g. of a card, upon manufacturing and is read out from the ROM to acquire the speed indicator data for a card.

It is preferred that the acquiring of the speed indicator data is executed when the cards are installed. In this way, the speed indicators are available immediately after installation of the flash memory cards and are immediately operable by the method of the invention. This is especially useful with the embodiment according to FIG. 2 where a second flash memory card 3 may be inserted or substituted via an memory extension slot. However, acquiring of speed indicator data also conceivable at an arbitrary point in time after insertion of a new card by triggering via a user command.

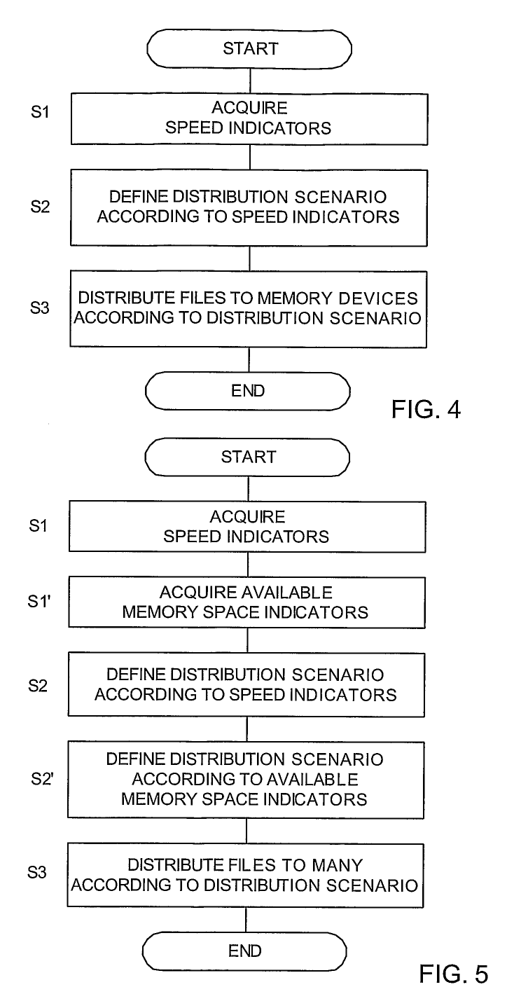

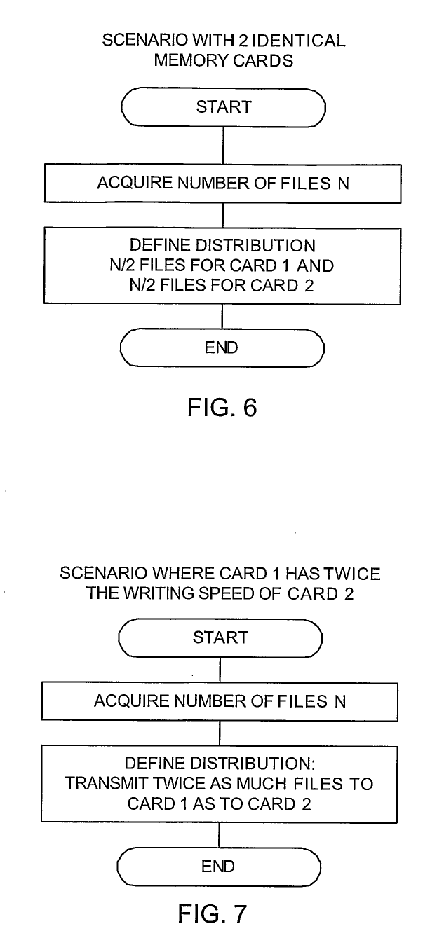

FIG. 4 shows a flow chart which shows the method of the invention for distributing data files within the MP3-player 2. Upon initializing of the MP3-player for MP3-file transfer, the method starts with step S1 in which speed indicator data of each available device are acquired through the use of the speed indicator means 8. Upon acquiring the speed indicators, step S2 is performed in which the distribution scenario is defined according to the acquired speed indicators. The defining of distribution scenario will be explained later with reference to FIGS. 6 and 7. Upon step S2, the method proceeds to step S3 where the received MP3-files are distributed to the flash memory cards 3 and 4 according to the distribution scenario. The distribution scenario defined in step S2 provides for an evenly distributed, i.e. balanced file transfer among the two flash memory cards 3 and 4. Hence, the writing speed of data files which are received by the serial interface means 9 to the flash memory cards via the file distribution means 5 can be substantially increased compared to conventional methods since it can simultaneously be written on the flash cards 3 and 4. This eases the danger of a jammed serial communication line connected to the serial interface means 9 due to the comparably slow writing speed capability of the flash memory cards 3 and 4.

FIG. 5 shows a flow chart illustrating the method according to the invention which comprises basically the same steps as the method shown in FIG. 4 but includes additionally a step S1′ and a step S2′ to further acquire memory space indicators and to further define the distribution scenario according to available memory space in the flash memory cards. With this consideration of the available memory space in the flash memory cards 3 and 4, an overflow of a flash memory card due to the writing of a file that is larger than the available space memory is avoided even thought that this memory card would be the faster one.

FIG. 6 refers to a scenario where the two flash memory cards 3 and 4 have equal size and writing speed. The example of defining a scenario within the file distribution method refers to the embodiment where the file distribution means 5 are incorporated in the host 1 (cp. FIG. 3). It is assumed that the speed indicator data are already acquired by the speed indicator means 8 so that these information can be used for defining the distribution scenario. In a first step, the number of files to be transferred are acquired. This number is denoted with N. The next step, is to define a distribution according to this data within the file distribution stage 7. Since the speed indicator of both flash memory cards 3 and 4 are identical, a distribution is defined by dividing the total number of files N by the total number of memory flash cards available, i.e. here two (2). Therefore, according to the distribution scenario the outgoing files are alternately assigned to the flash memory cards 3, 4 to increase the writing speed by simultaneously using all memory cards available for writing. Assumed that all files are of the same size this would theoretically provide for an increase of factor two for the writing speed.

The MP3 files are transmitted via serial interface means 9 using a time multiplexing method. However, also other data transfer techniques are conceivable, in particular, radio frequency based wireless transmission techniques (e.g. 802.11b standard).

FIG. 7 refers to a scenario where card one (1) has twice the writing speed of card two (2). Also with this method, the number of files N is acquired. However, since the speed indicator data are different because the writing speed of the flash memory cards are different, also a different file distribution scenario has to be defined in order to increase writing speed by simultaneously writing data files to the flash memory cards thereby balancing the transfer load for each card according to the respective writing speed. Hence, since the writing card 1 has a writing speed which is twice the writing speed of card 2, also twice as much files than for card 2 are assigned for card 1 for transmitting.

It should be observed that optionally the filed size can also be considered when defining a distribution scenario. This is especially useful if the data file size is substantially different among the files to be transferred. For example, if a file has almost twice the size of another file, this file will be assigned to the flash memory card with the higher writing speed. Accordingly, it is possible to better balance transfer load to each of the flash memory cards which results in an increased total writing speed compared to a conventional system.

As mentioned before, intermediate storage means 6 like a buffer memory can be integrally provided with the file distribution stage 7. The use of this intermediate storage means 6 provide for a buffering which also provides for an even transfer load to each of the flash memory cards. In this embodiment, it is preferred that the size of the intermediate storage means 6 is adapted to always contain at least two files. This secures the possibility of always simultaneously transfer two files from a host 1 to the MP3-player. However, it has to be noted that the method of the invention is also applicable to memory systems with more than two memory devices. In particular, the more memory devices are available, the more can the transfer load be evenly balanced and the better are the results in increase of writing speed by distributing data files simultaneously to each memory device.

Furthermore, it has to be observed that the method of the invention may be embodied as computer program product which contains software code portions. The computer program product can further be incorporated in a data carrier like a CD or DVD disc, floppy disc, etc. For executing the method of the invention embodied as computer program product, the data carrier is connected to either the host 1 or the MP3-player 2 and the software code portions are stored in a memory of a programmable device or system.

It has to be appreciated that reference signs within the claims are only given for illustrative purpose and shall not be construed as limiting the scope of the matter for which protection is thought.

1. Method of distributing data files to a memory system having more than one memory devices, each being arranged for storing at least one data file comprising the following steps of acquiring speed indicators indicating the writing speed of data into each memory device (S1);
defining a distribution scenario according to the acquired speed indicators (S2); and
distributing data files to the memory devices according to the defined distribution scenario (S3).

2. Method according to claim 1, wherein
the step of acquiring of speed indicators further comprises an acquiring of memory space indicators indicating the available memory space for each memory device (S1′); and
the step of defining a distribution scenario further comprises considering the acquired memory space indicators (S2′).

3. Method according to claim 1, wherein the step of acquiring speed indicators is performed by writting a predefined test data file in each memory device and measuring the time duration required for writing the test data file to the respective memory device.

4. Method according to claim 3, wherein step of acquiring speed indicators is performed when the memory devices are installed into the memory system.

5. Method according to claim 1, wherein the step of distributing the digital data files includes a buffering of data of the data files.

6. A computer program product directly loadable into the memory of a programmable device or system comprising software code portions for performing the steps of a method according to claim 1 when said product is run on the programmable device or system.

7. A data carrier comprising the computer product as claimed in claim 6.

8. Memory system for storing data files comprising at least two memory devices (3,4);
means (8) for acquiring speed indicators indicating the writing speed of data into each memory device;
means (7) for defining a distribution scenario according to the acquired speed indicators, wherein the means (7) for defining a distribution scenario are arranged for a cooperation with the means (8) for acquiring speed indicators, and
means (5) for distributing data files to the memory devices according to the defined distribution scenario.

9. Memory system according to claim 8 wherein at least one of the memory devices is releasable mounted in the memory system.

10. Memory system according to claim 8 wherein the means (5) for distributing data files include a intermediate storage means (6) for buffering of data of the data files.

11. Memory system according to claim 8 which comprises serial interface means (9) for receiving the data files wherein the serial interface means (9) are applicable for a USB, FireWire or RS 232C connections.

12. Multimedia device (2) comprising the memory system according to claim 8.

13. Multimedia device according to claim 12 wherein the multimedia device (2) is a MP3-player.

14. Host system for transferring data files to a memory system, which memory system is arranged for storing data files and comprise at least two memory devices therefore, comprising
means (8) for acquiring speed indicators indicating the writing speed of each memory device;
means (7) for defining a distribution scenario according to the acquired speed indicators, wherein the means (7) for defining a distribution scenario are arranged for a cooperation with the means (8) for acquiring speed indicators, and
means (5) for distributing digital data files to the memory devices according to the defined distribution scenario.
